(19) United States
(12) Patent Application Publication
(10) Pub. No.: US 2023/0049219 A1
(43) Pub. Date: Feb. 16, 2023

(54) APPLICATION USER JOURNEY MANAGEMENT

(71) Applicant: Avast Software s.r.o., Praha 4 (CZ)

(72) Inventors: Martin Neznal, Prague (CZ); Roman Christov, Prague (CZ)

(73) Assignee: Avast Software s.r.o., Praha 4 (CZ)

(21) Appl. No.: 17/399,884

(22) Filed: Aug. 11, 2021

(51) Int. Cl. G06F 9/50; G06F 16/903

(52) U.S. Cl. CPC G06F 9/5027; G06F 16/90335

(57) ABSTRACT

An application activation method includes enabling an activation of one or more applications, including an activation of a first application, on a computing device. A first plurality of interactions of a user with the one or more applications on the computing device are detected. A first offer to renew the activation of the first application is generated based on the first plurality of interactions of the user. The first offer is provided to the user via the computing device. An acceptance of the first offer is received from the user, and the activation of the first application is renewed responsive to receiving the acceptance of the first offer.

### TECHNICAL FIELD

The invention relates generally to application management in computer systems.

### BACKGROUND

The user experiences of users of an application during the lifecycle of the application are often optimized through repetitive work done by human analysts. Analysts may manually analyze data attributes associated with one or more application users for example on a daily basis in order to identify actions to be taken in order to personalize a user's experience over a period of time. Analysts may notice a change in a general metric like user retention of application users. However, analysts may not be able to effectively and in a reproducible manner identify changes in metrics corresponding to particular user segment combinations. For example, an analyst may not as a practical matter notice a change in retention rate of application users that use a particular credit card and that had activated a particular application via a particular online resource.

### SUMMARY

This Summary introduces simplified concepts that are further described below in the Detailed Description of Illustrative Embodiments. This Summary is not intended to identify key features or essential features of the claimed subject matter and is not intended to be used to limit the scope of the claimed subject matter.

An application activation method includes enabling an activation of one or more applications, including an activation of a first application, on a computing device. A first plurality of interactions of a user with the one or more applications on the computing device are detected. A first offer to renew the activation of the first application is generated based on the first plurality of interactions of the user. The first offer is provided to the user via the computing device. An acceptance of the first offer is received from the user, and the activation of the first application is renewed responsive to receiving the acceptance of the first offer.

A further application activation method is provided including enabling on a plurality of computing devices a plurality of activations of one or more applications including a plurality of activations of a first application. A first plurality of features of each of the plurality of activations of the one or more applications on the plurality of computing devices are determined. A plurality of events including one or more of renewals or unsubscribes of each of the plurality of activations of the one or more applications on the plurality of computing devices are determined. A classifier is trained based on the first plurality of features of each of the plurality of activations of the one or more applications on the plurality of computing devices and the plurality of events of each of the plurality of activations of the one or more applications on the plurality of computing devices. A particular activation of the one or more applications including a particular activation of the first application is enabled on a particular computing device. A first plurality of features of the particular activation of the one or more applications are determined. The classifier is applied to the first plurality of features of the particular activation of the one or more applications to generate a first offer to renew the particular activation of the first application. The first offer is provided to a particular user via the particular computing device. An acceptance of the first offer is received from the particular user, and particular activation of the first application is renewed responsive to receiving the acceptance of the first offer.

Further provided is an application activation system including one or more processors and one or more storage devices coupled to the one or more processors and storing computer-executable instructions, wherein the computer-executable instructions, when executed by the one or more processors, cause the system to perform operations including enabling on a plurality of computing devices a plurality of activations of one or more applications including a plurality of activations of a first application, determining a first plurality of features of each of the plurality of activations of the one or more applications on the plurality of computing devices, and determining a plurality of events including one or both of renewals or unsubscribes of each of the plurality of activations of the one or more applications on the plurality of computing devices. The operations also include training a classifier based on the first plurality of features of each of the plurality of activations of the one or more applications on the plurality of computing devices and the plurality of events of each of the plurality of activations of the one or more applications on the plurality of computing devices, enabling on a particular computing device a particular activation of the one or more applications including a particular activation of the first application, and determining a first plurality of features of the particular activation of the one or more applications. The operations further include applying the classifier to the first plurality of features of the particular activation of the one or more applications to generate a first offer to renew the particular activation of the first application, providing the first offer to a particular user via the particular computing device, receiving an acceptance of the first offer from the particular user, and renewing the particular activation of the first application responsive to receiving the acceptance of the first offer.

Further provided is a non-transitory computer readable storage medium having computer-executable instructions that when executed cause one or more processors to perform operations including enabling on a plurality of computing devices a plurality of activations of one or more applications including a plurality of activations of a first application, determining a first plurality of features of each of the plurality of activations of the one or more applications on the plurality of computing devices, and determining a plurality of events including one or both of renewals or unsubscribes of each of the plurality of activations of the one or more applications on the plurality of computing devices. The operations also include training a classifier based on the first plurality of features of each of the plurality of activations of the one or more applications on the plurality of computing devices and the plurality of events of each of the plurality of activations of the one or more applications on the plurality of computing devices, enabling on a particular computing device a particular activation of the one or more applications including a particular activation of the first application, and determining a first plurality of features of the particular activation of the one or more applications. The operations further include applying the classifier to the first plurality of features of the particular activation of the one or more applications to generate a first offer to renew the particular activation of the first application, providing the first offer to a particular user via the particular computing device, receiving an acceptance of the first offer from the particular user, and renewing the particular activation of the first application responsive to receiving the acceptance of the first offer.

Further provided is a method including enabling on a plurality of computing devices a plurality of activations of one or more applications including a plurality of activations of a first application. A first plurality of features of each of the plurality of activations of the one or more applications on the plurality of computing devices are determined, the first plurality of features including a first plurality of interactions of each of a plurality of users with the one or more applications on each of the plurality of computing devices respectively. A plurality of events including one or both of renewals or unsubscribes of each of the plurality of activations of the one or more applications on the plurality of computing devices are determined. A classifier is trained based on the first plurality of features of each of the plurality of activations of the one or more applications on the plurality of computing devices and the plurality of events of each of the plurality of activations of the one or more applications on the plurality of computing devices. A particular activation of the one or more applications including a particular activation of the first application is enabled on a particular computing device. A first plurality of features of the particular activation of the one or more applications are determined. The classifier is applied to the first plurality of features of the particular activation of the one or more applications to generate a first offer regarding the first application. The first offer is provided to a particular user via the particular computing device. A second plurality of features of the particular activation of the one or more applications are determined after providing the first offer to the particular user, the second plurality of features of the plurality of activations of the one or more applications including a second plurality of interactions of each of the plurality of users with the one or more applications on each of the plurality of computing devices respectively. The classifier is applied to the second plurality of features of the particular activation of the one or more applications to generate a second offer to renew the particular activation of the first application, and the second offer is provided to the particular user via the particular computing device.

### BRIEF DESCRIPTION OF THE DRAWING(S)

A more detailed understanding may be had from the following description, given by way of example with the accompanying drawings. The Figures in the drawings and the detailed description are examples. The Figures and the detailed description are not to be considered limiting and other examples are possible. Like reference numerals in the Figures indicate like elements wherein:

FIG. 1 is a diagram showing an environment in which application user journeys are optimized and activations of applications are managed according to illustrative embodiments.

FIG. 2 is a diagram showing an exemplary timeline grouping of user journey timelines for hypothetical users of a particular application administered on computing devices with reference to the components of FIG. 1.

FIG. 3 is a diagram showing a process flow enabled by components of FIG. 1.

FIGS. 4A and 4B are diagrams showing a particular implementation of the process flow of FIG. 3.

FIGS. 5 and 6 are a diagrams showing application activation methods according to illustrative embodiments.

FIG. 7 is a diagram showing an extension to the application activation method of FIG. 6.

FIG. 8 shows an exemplary computer system for performing described methods according to illustrative embodiments.

### DETAILED DESCRIPTION OF ILLUSTRATIVE EMBODIMENT(S)

Described herein are tools for analyzing activity of an application user across application milestones over a time period and for providing notices including recommendations and offers to application users based on individual user characteristics. A notice can include a change of price notification, advisory message, or instructions regarding a particular application. The general goal of a notice is to increase user retention rate, satisfaction, revenue or other important metric associated with use of a particular application or group of applications.

Notices including recommendations and offers are generated automatically, with no human input needed, in real-time, across a plurality of application milestones over a time period, using information about the application user including for example historical behavior, actions, and a current state of an application subscription. Personalization of a notification is optimized with respect to an ensemble of retention metrics, for example application renewal rate, customer experience, net promoter Score™ (“NPS”), revenue, and lifetime value (“LTV”).

An application user's application use experience over a time period can be optimized with respect to a plurality of milestones. Milestones can include for example the time of application purchase or activation, a particular number of days after application purchase or activation, or a particular number of days before the expiration of the application's activation. The application user's application use experience including notifications is personalized based on an analysis of events occurring between milestones. An ensemble of machine learning classifiers can be enabled to work together to generate an optimal recommendation, offer, or combination recommendation and offer at each of a plurality of milestones during the operation of a particular application.

In a particular embodiment, a classifier is provided that analyzes user behavior after purchase of an application license and activation of the application. The classifier provides, if necessary, instructions enabling a proactive intervention to the user for example a contact from a customer care representative, an offer to re-subscribe to a service of the application, or other action related to a to operation of the application. In a further embodiment, a classifier is provided that analyzes user behavior before expiration of the user's application license and generates instructions to offer the user a momentary discount for continued application use, to offer the user an early renewal incentive, to allow the user to unsubscribe or initiate an unsubscribe action, to initiate network-based communication (audio or text) from a customer care representative, or to perform other action related to operation of the application.

The illustrative embodiments described herein function to create a personalized experience for an application user resulting in an increase in user retention rate, revenue, and user satisfaction related to the application and a decrease in user refunds, chargebacks, and unsubscribes related to the application. Determining understandings of user behavior is enabled, and forecasting of user actions is enabled. The illustrative embodiments enable discovery of unsatisfied users and providing unsatisfied users with incentives to prevent them from uninstalling a particular application.

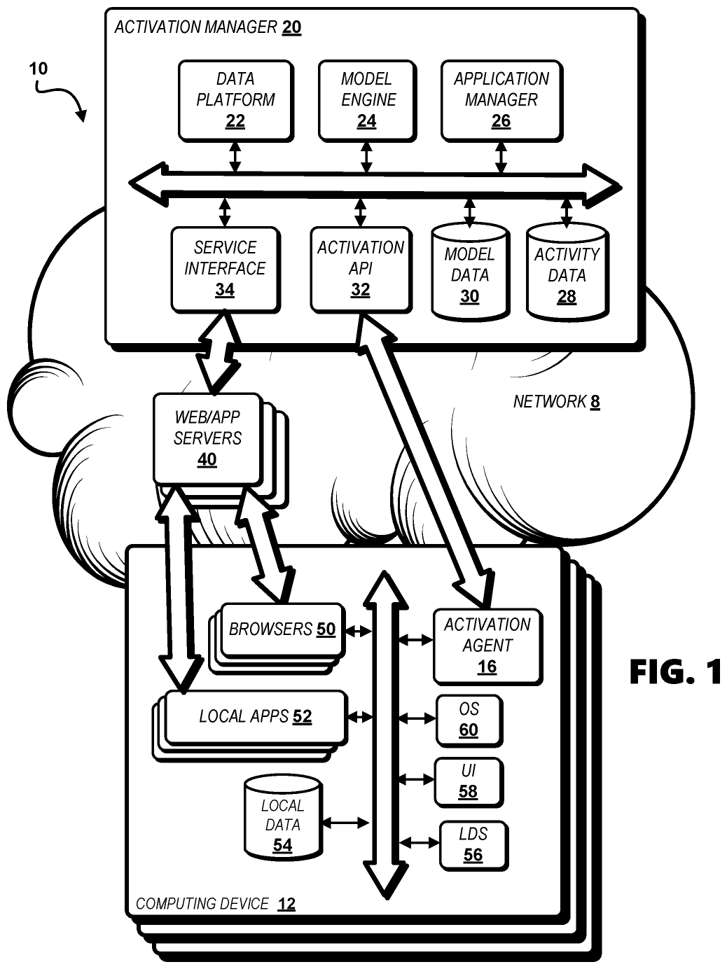

Referring to FIG. 1, an environment 10 enabled by a computer network 8 is illustrated in which activation of local applications 52 and online applications are managed by an activation manager 20. The computer network 8 includes one or more wired or wireless networks or a combination thereof, for example a local area network (LAN), a wide area network (WAN), the internet, mobile telephone networks, and wireless data networks such as Wi-Fi™ and 3G/4G/5G cellular networks. An activation agent 16 enables monitoring of local and online application use on a computing device 12 to provide the activation manager 20 with user application use data.

The activation manager 20 is enabled to monitor online applications enabled by website servers or application servers 40 (hereinafter “web/app servers”) by a service interface 34. The activation manager 20 can further monitor local applications 52 enabled by the computing device 12 and online applications enabled by the web/app servers 40 via the activation agent 16, for example via browsers 50 and respective local applications 52. The web/app servers 40 can function to enable local applications 52 or components of local applications 52. The web/app servers 40 can further function to enable online services including network-based applications accessible via a browser 50, which browser 50 can be monitored by the activation agent 16 to determine access to and use of online services by a user of the computing device 12.

The activation manager 20 coupled to a computing device 12 enables notifications to be provided to the computing device 12 via an activation agent 16 and use data to be gathered from the computing device 12 via the activation agent 16. The activation manager 20 and the activation agent 16 activate, administer, monitor, and engage particular local applications 52 and particular network-based applications enabled by web/app servers 40, for example local and network-based applications offered under one or more proprietary brands. The activation manager 20 via the activation agent 16 monitors user activity on the computing device 12 including a user's use of the particular local applications 52 and the particular network-based applications. Data obtained from monitoring by the activation agent 16 is fed to the activation manager 20 via an activation application program interface (“API”) 32. The activation manager 20 can further monitor user activity via the service interface 34 including use by a user of particular network-based applications enabled by web/app servers 40.

The activation agent 16 can be provided as a standalone application on a computing device 12 or can be provided integral with or as an extension or plugin to one or more browser applications 50 (“browsers”). The activation agent 16 provides notices to a user via a user interface 58. The activation agent 16 can activate, administer, monitor, and engage particular local applications 52 for example standalone applications and plugins, add-ons, or extensions to other applications. The activation agent 16 gathers user interaction data, for example screen views of displays generated by particular local applications 52, logins to particular local applications 52, and logins to particular network-based applications (e.g., via a local application 52 or via a browser 50), which interaction data is transmitted to the activation manager 20 via the activation API 32. The activation agent 16 can further monitor interactions with online services and logins to online services enabled by the local applications 52, which interaction and login data is transmitted to the activation manager 20 via the activation API 32. The activation manager 20 provides instructions to the activation agent 16 via the activation API 32 for enabling the activation agent 16 to provide notifications to a user via the user interface 58. An operating system (“OS”) 60 is executed on the computing device 12 which enables integration of the activation agent 16 with the browsers 50 and the local applications 52.

A user via the computing device 12 can engage web/app servers 40 via a browser 50 or local application 52 to register new accounts and modify account values (e.g., account passwords, credit card information, and home address) on online services for example enabled by websites and applications. The activation agent 16 monitors screen views and access to local services and online services, and the activation agent 16 logs screen views and access to local services and online services in a local datastore 54. The activation agent 16 further provides logs to the activation manager 20 via the activation API 32 for storage in the activity datastore 28. A location determining system (“LDS”) 56, for example including a Global Positioning System (“GPS”) receiver and other GPS hardware, is provided for determining a location of the computing device 12, logs of which are also provided to the activation manager 20 by the activation agent 16 via the activation API 32 for storage in the activity datastore 28. recommend

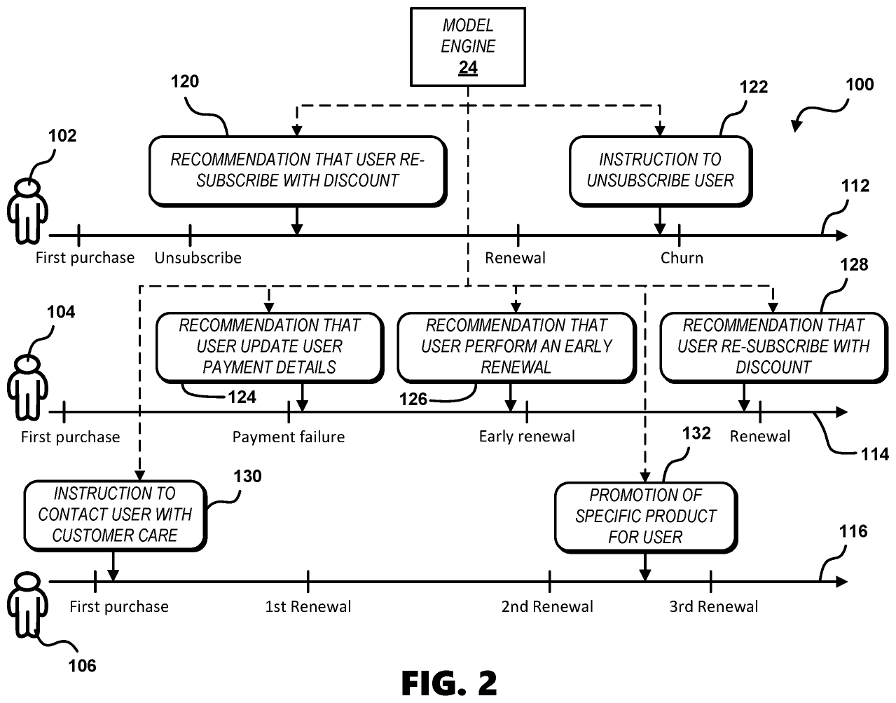

Referring to FIG. 2, an exemplary timeline grouping 100 of first, second, and third exemplary user journey timelines 112, 114, 116 for hypothetical first, second, and third users 102, 104, 106 of a particular application activated and administered by the activation manager 20 via the activation agent 16 on computing devices 12. The particular application can include for example one or both of a local application 52 or a network-based application enabled by a web/app server 40. Shown are exemplary instructions which can be generated by the model engine 24 by applying a classifier to aggregated data related to the respective first, second, and third users 102, 104, 106. Particularly, the first, second, and third exemplary user journey timelines 112, 114, 116 show system interventions at different milestones in which different actions are instructed.

The first exemplary user journey timeline 112 of the first user 102 includes a first purchase event indicating when the particular application is initially activated for the first user 102, an unsubscribe event indicating when the first user 102 de-activates the particular application (e.g., via unsubscribing from a service enabled by the application), a renewal event indicating when a user renews activation of the particular application (e.g., via a service subscription renewal), and a churn event indicating when the first user 102 stops using or finally de-activates the particular application or finally unsubscribes from a service enabled by the application.

The model engine 24 determines a price discount for the first user 102 and produces a recommendation that the first user 102 re-subscribe to a service enabled by the particular application to reactivate the application with the price discount at a milestone 120 along the first exemplary user journey timeline 112. The model engine 24 determines the price discount and the activation agent 16 delivers the recommendation with the price discount at the milestone 120 via the user interface 58 after the unsubscribe event to incentivize the first user 102 to renew activation of the particular application.

The model engine 24 further produces an instruction to unsubscribe the user from a service enabled by the particular application to de-activate the particular application at a milestone 122 along the first exemplary user journey timeline 112, allowing the application to be deactivated without further incentives provided to the first user 102. The unsubscribing is performed by the activation agent 16 in communication with a local application 52, or alternatively by the service interface 34 in communication with a web/app server 40.

The second exemplary user journey timeline 114 includes a first purchase event indicating when the particular application is initially activated for the second user 104, a payment failure event indicating when the user 104 fails to enable a payment to renew activation of the particular application (e.g., expired credit card causes payment denial), an early renewal event indicating when a user renews activation of the particular application prior to a renewal deadline (e.g., via a service subscription renewal), and a renewal event indicating when a user again renews activation of the particular application (e.g., via a service subscription renewal).

The model engine 24 produces a recommendation that the second user 104 update payment details of the second user 104 at a milestone 124 along the second exemplary user journey timeline 114 after the payment failure event. The activation agent 16 delivers the recommendation to update payment details at the milestone 124 via the user interface 58 after the payment failure event to incentivize the second user 104 to update their payment details (e.g., credit card expiration date).

The model engine 24 further produces a recommendation that the second user 104 perform an early renewal at a milestone 126 along the second exemplary user journey timeline 114 after the recommendation to update user payment details at the milestone 124 to request the second user 104 renew activation of the particular application prior to a renewal deadline. The activation agent 16 delivers the recommendation that the second user 104 perform an early renewal at a milestone 126 via the user interface 58.

The model engine 24 further determines a price discount for the second user 104 and produces a recommendation that the second user 104 re-subscribe to a service enabled by the particular application to reactivate the particular application with the price discount at a milestone 128 along the second exemplary user journey timeline 114. The model engine 24 determines the price discount and the activation agent 16 delivers the recommendation with the price discount at the milestone 128 via the user interface 58 after the early renewal event to incentivize the second user 104 to renew activation of the particular application.

The third exemplary user journey timeline 116 includes a first purchase event indicating when the particular application is initially activated for the third user 106, a first renewal event indicating when the third user 106 renews activation of the particular application (e.g., via a service subscription renewal), a second renewal event indicating when the third user 106 again renews activation of the particular application (e.g., via a service subscription renewal), and a third renewal event indicating when the third user 106 yet again renews activation of the particular application (e.g., via a service subscription renewal). The model engine 24 produces an instruction to contact the third user with customer care at a milestone 130 along the third exemplary user journey timeline 116. The activation agent 16 can facilitate communication with an artificial intelligence customer care agent or human customer care agent at the milestone 130 via the user interface 58 after the first purchase event for example to provide explanation to the third user 106 of features of the particular application. Alternatively, communication with an artificial intelligence or human customer care agent can be facilitated at the milestone 130 by other communication protocol (e.g., phone or Short Message Service [“SMS”]).

The model engine 24 further generates a promotion of a specific product for the third user 106 at a milestone 132 along the third exemplary user journey timeline 116. The activation agent 16 delivers the promotion of the specific product to the third user 106 at the milestone 132 via the user interface 58 after the second renewal event to incentivize the third user 106 to activate one or more additional applications or to activate additional services provided via the particular application.

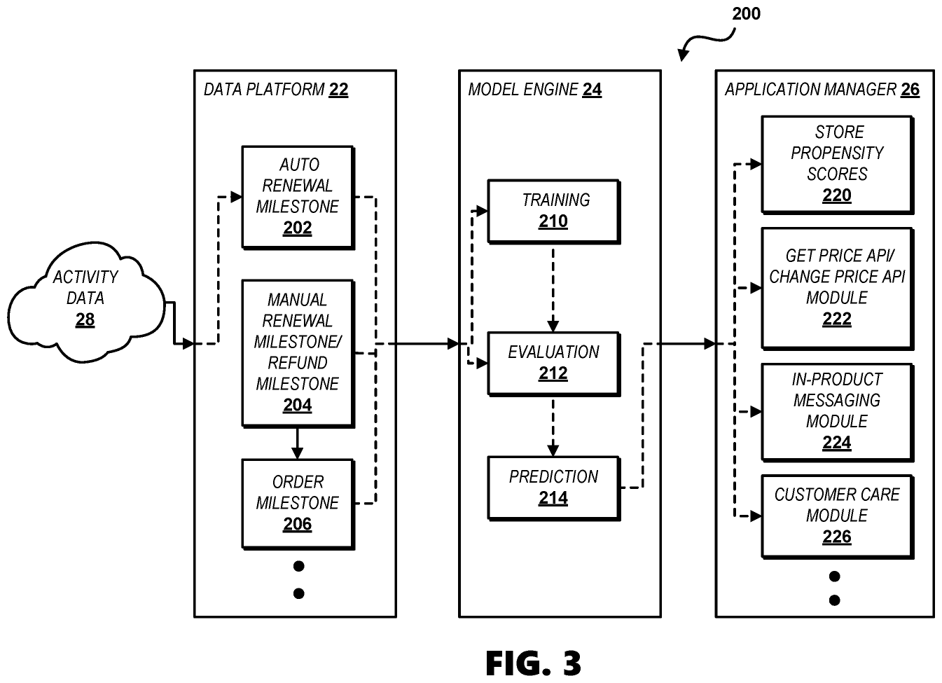

Referring to FIG. 3, a process flow 200 enabled by components of the environment 10 is shown. The data platform 22, for example a consumer data platform (“CDP”), is enabled to gather and aggregate data related to orders and use of applications across different milestones of users. An auto renewal milestone 202 can correspond for example to a date (50) days before expiration of a subscription to the particular application. A manual renewal milestone or refund of purchase price milestone 204 can correspond for example to a date (20) days before expiration of a subscription to the particular application. An order milestone 206 can correspond for example to the expiration date of a subscription to the particular application. The milestones can further include for example the time of the initial order of a particular application, thirty (30) days after the initial order of the particular application, and thirty (30) days after renewal of the particular application. Data is gathered via the activation agent 16 on a computing device 12 where the particular application (e.g., a local application 52) is installed. Alternatively, data is gathered via a service interface 34 in communication with web/app servers 40 enabling the particular application, for example enabling network-based components of the particular application.

Data sources of gathered data can include for example customer care data, click-logs, antivirus application event logs, virtual private network (“VPN”) activity, Doodle™ application feeds, emails, Net Promoter Score™ (“NPS”), internet browser activity, and cleanup application activity. Gathered data for each user is stored in an activity datastore 28. Beneficially, gathered data is stored in a database of the activity datastore 28 as a plurality of features in a plurality of tables, for example four hundred (400) features in forty (40) tables. Each row of a table can correspond to an application license corresponding to an expiration date in a certain number of days of a subscription to a particular application or an online service enabled by a particular application. Columns of the tables can identify features reflecting the gathered data. Features beneficially include static features for example country where the user resides, time length of application license, and type of application licensed. Features beneficially also include dynamic features, for example a number of application screen views in the certain number of days before or after a particular milestone in a particular time window (e.g., 60 days or 180 days) and a number of application heartbeats in the certain number of days before or after the particular milestone in the particular time window (e.g., 60 days or 180 days).

A portion of a hypothetical exemplary database table which can be stored in the activity datastore 28 for a plurality of users of a plurality of computing devices 12 is shown in Tables 1 and 2. The columns of the exemplary database table include features for each application license of a particular application represented by rows of the exemplary database table. The features include a user id of the application user, an order id of the application license, a country label indicating the application user's country of residence, a brand label indicating the product brand of the application license, a length of time the application license is scheduled to be active absent a renewal, an order date of the application license, an expiration date of the application license, a renewal date when the application license was renewed if it had been renewed, and a price paid for the license by the user.

The features of the columns of the exemplary database table further include for each application license the type of currency paid by the application user for an application license, a total number of purchases by the application user (e.g., the particular application license purchase and other license purchases), the total number of subscription cycles completed since the application license was initially activated, the number of advertisements seen by the application user via the particular application, the number of advertisements generated by the particular application that were clicked on (or otherwise engaged) the application user, the hardware quality of the computing device on which the application is installed (e.g., processor speed, memory, storage), the application user's level of activity with the application, and the Net Promoter Score™ (“NPS”) based on a survey provided to the application user. Additional columns listing additional features can be included in the exemplary database, and the listed features are non-limiting.

TABLE 1
(continued at Table 2)

| | | | | | license | | | | |
|---|---|---|---|---|---|---|---|---|---|
| user | order | | product | | length | | expiration | renewal | price |
| id | id | country | type | brand | of time | order date | date | date | paid |
| 1 | 1 | US | AV | Avast ™ | 12 | 2020 Jul. 10 | 2021 Jul. 10 | 2021 Jul. 5 | 80 |
| 1 | 2 | US | VPN | Avast ™ | 24 | 2021 Apr. 11 | 2023 Apr. 11 | — | 130 |
| 2 | 3 | UK | AV | AVG ™ | 12 | 2020 Jul. 10 | 2021 Jul. 10 | — | 50 |
| 3 | 4 | France | AV | Avast ™ | 12 | 2020 Jul. 10 | 2021 Jul. 10 | 2021 Jul. 17 | 60 |
| . . . | | | | | | | | | |

TABLE 2
(continued from Table 1)

| | | total | | | number | | | | |
|---|---|---|---|---|---|---|---|---|---|
| | | number of | | number | of | | activity | | |
| user | | purchases | subscription | of seen | clicked | hardware | with the | | |
| id | currency | by user | cycle | ads | ads | quality | application | NPS | . . . |
| 1 | USD | 5 | 3 | 10 | 3 | 5 | 7 | 8 | |
| 1 | USD | 6 | 0 | 3 | 1 | 5 | 10 | — | |
| 2 | GBP | 0 | 0 | 13 | 7 | — | 5 | 6 | |
| 3 | EUR | 2 | 1 | — | — | 10 | 7 | — | |
| . . . | | | | | | | | | |

Features gathered from different data sources can be grouped for example into four categories: engagement, licensing, satisfaction and static information. By these categories and features (e.g., five hundred [500] features in the model) a description of the user and the user's activities can be achieved with a high level of detail. Some of these features do not change over time, such as country or the subscription type, which features can be used in their raw form and which features can be considered static features. Other features, such as features related to user engagement and licensing features, are likely to change over time (e.g., dynamic features), and for such features it is beneficial to compute aggregates over a time period (e.g., over the last 7 days, last 1 month, last 2 months, or last 6 months). Training is performed or predictions are computed at milestones of a user journey timeline (e.g., during a purchase, a month after purchase, a month or a few days before an application license expiration date).

Under the engagement category, features can include for example interactions by a user with screen displays, pop-ups, and advertisements across a plurality of applications provided by a particular application provider, which particular application provider enables the activation manager 20 and the activation agent 16. Under the engagement category, features can further include a user's number of active days on one or more applications of the particular application provider over a particular time period (e.g., the last 2 months), or the number of days from last active day on the one or more applications. Under the licensing category, features can include how long a user has been using one or more applications provided by the particular application provider, how much money has been paid by the user to the particular application provider for one or more applications, a number of applications of the particular application provider used by the user (e.g., a particular application subject to renewal notifications plus additional installed applications of the application provider). Under the satisfaction category, features can include how satisfied a user is with one or more applications provided by the particular application provider (e.g., based on a user survey). Under the static information category, features can include user location and user location geography, hardware quality of the user's computing device, and the type of application subscription (e.g., monthly renewal, yearly renewal, biyearly renewal). Under the static information category, features can further include the number of applications installed on one or more computing devices operated by the user (e.g., the number of installed antivirus applications of other application providers) serving a similar function as that of the particular monitored application (e.g., a monitored antivirus application of the particular application provider) installed on one or more computing devices operated by the user.

The model engine 24 institutes training (step 210) of a machine learning model including one or more classifiers based on the features, which features are beneficially aggregated and precomputed by the data platform 22. The classifier can implement for example one or more of logistic regression, random forest or neural network (e.g., with tuned parameters and architecture) models. The one or more classifiers take the data aggregated and computed at time periods corresponding to specific milestones (e.g., the milestones 202, 204, 206), and the one or more classifiers predicts one or more probabilities of one or more respective outputs.

One or more classifiers are trained in the training step 210 towards a plurality of event outputs including for example renewal of activation of an application, unsubscribing from an application, return of an application license, cancelation of an application service caused by a high price, indication of dissatisfaction of the user, and indication of a willingness of a user to buy other products. One or more classifiers with one or more of these outputs can be trained during selected individual milestones, a plurality of milestones, or all milestones in a user journey timeline. Trained classifiers are stored in the model datastore 30. The event output of a trained classifier is beneficially a probability that expresses how likely a user will perform, initiate, or trigger one or more particular actions or results based on user actions.

Evaluation of the trained classifier is instituted (step 212) based on one or more metrics including accuracy, precision, recall and F1 scores (i.e., Sørensen-Dice coefficients). Evaluation of a trained classifier is further instituted by a technique based on the analysis of the classifier in the bottom percentiles and top percentiles of outputs of the classifier. In an exemplary implementation, a segment of users corresponding to a relatively low application renewal rate and a segment of users corresponding to a relatively high application renewal rate are determined. Beneficially, segments of users from the bottom 30% and the top 30% of predicted outputs corresponding respectively to low predicted probabilities and high predicted probabilities are selected. Precision, recall, and f1 score are measured in the selected segments.

The trained classifier, or a plurality of trained classifiers, is used to achieve predictions 214 of particular actions of a user or results based on user actions. Predictions can take the form of propensity scores which are stored by the application manager 26 (step 220), for example in the model datastore 30. A propensity score can for example be provided as a renewal score which defines a propensity for a user to renew activation of the particular application, and which renewal score can be used to set a price for activation renewal via a get price API/change price API module 222. Alternatively, a propensity score can for example be used in determining in-product messaging via an in-product messaging module 224 and customer care communications via a customer care module 226 to a user. In-product messaging and customer care communications can be related for example to application activation renewal (e.g., an offer to renew) or extensions of service (e.g., an offer to activate another application).

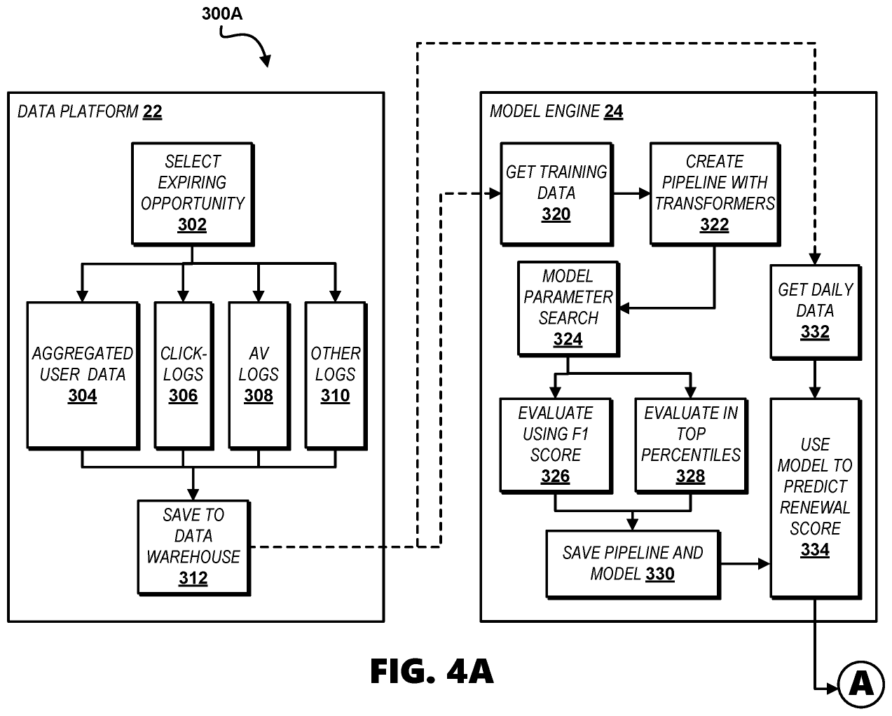

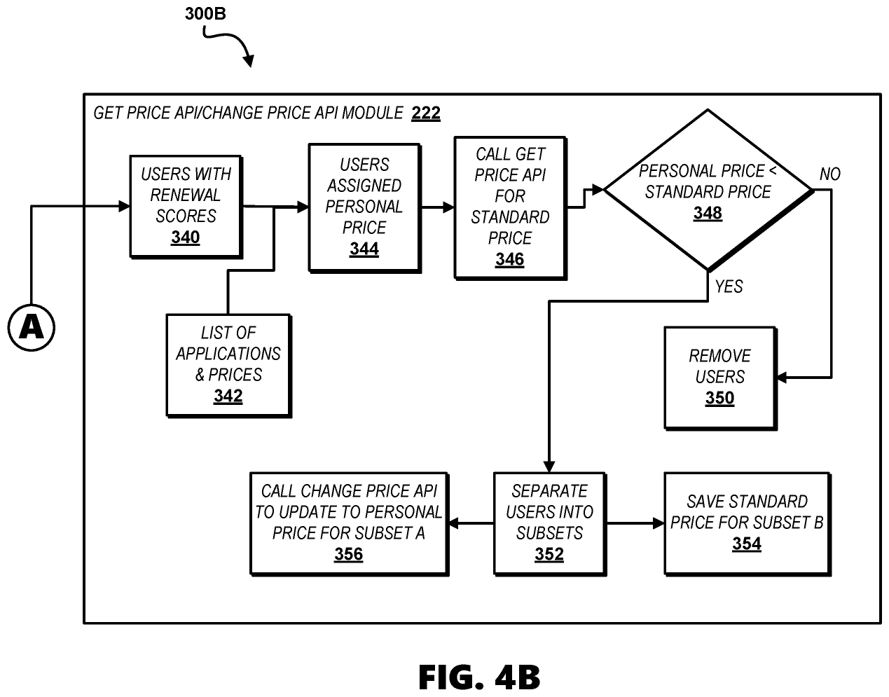

Referring to FIGS. 4A and 4B, a particular implementation of the process flow 200 is provided in an auto renewal process 300A, 300B in which a model is trained to determine a renewal offer for a particular application with pricing to provide to the user at a particular milestone. In the auto renewal process 300A, 300B a milestone in the form of an expiring renewal opportunity is designated (step 302) via the data platform 22. The renewal opportunity is to be rendered accessible to a user for a period of time (e.g., fifty [50] days) prior to expiration of an application activation, and a user is notified of the expiring renewal opportunity for example via a screen display on their computing device 12 via the activation agent 16.

During a model training process, features corresponding to a particular time period prior to the renewal opportunity (e.g., sixty [60] days prior to the renewal opportunity) are aggregated from a plurality of computing devices 12 via an activation agent 16. Features beneficially include aggregated user data 304, user click-logs 306, antivirus application logs 308, and other logs 310 indicating various user activity including user interactions with the application and including an indication of whether the particular application was renewed or not during the renewal opportunity. Features are aggregated and saved (step 312) as training data in a data warehouse enabled by the activity datastore 28.

The model engine 24 gets training data (step 320) for generating a random forest model via the data platform 22 and creates a pipeline with transformers (step 322). Alternatively other model types (e.g., logistic regression models, neural network models) can be generated. In the step 322, the training data is processed and transformed to a suitable format for the random forest model or other machine learning algorithm. The transforming includes for example feature selection (e.g., selecting correct columns or attributes to use in the algorithm), filtering out missing values, and adapting select attributes into a suitable format. A model parameter search is performed (step 324) and the model is evaluated using an F1 score (step 326) and evaluated in top percentiles (step 328). The pipeline and model are saved (step 330).

The saved model is used to predict a renewal score (step 334) for a particular user for whom it is determined whether a renewal offer will be offered. Data is obtained on a daily basis via a particular computing device 12 of the particular user via an activation agent 16. As in the training process, features corresponding to a particular time period (e.g., sixty [60] days) prior to the potential renewal opportunity are aggregated from the particular computing device 12 of the particular user. Features beneficially include aggregated user data 304, user click-logs 306, antivirus application logs 308, and other logs 310 indicating various user activity including user interactions with the application. Features are aggregated and saved (step 312) in the warehouse enabled by the activity datastore 28 as data for use in rendering predictions, which data is obtained by the model engine 24 (step 332) for use in predicting the renewal score (step 334) based on the trained model.

Referring to FIG. 4B, the auto renewal process 300A, 300B implements the get price API/change price API module 222. Indications of users and their determined renewal scores 340 are received from the model engine 24 by the get price API/change price API module 222 via an input “A”. A list of applications (e.g., local or network-based services) and prices of the applications 342 are maintained by the get price API/change price API module 222. Users are assigned a personal renewal price for their respective applications (step 344) based on the indications of users and their renewal scores 340 and the list of the applications and the prices of the applications 342. A get price API is called which determines a standard renewal price for the particular application (step 346). The standard renewal price for a particular application can for example depend on one or more of a product type of the particular application, a location of the user of the particular application (e.g., country of residence), or a license type of the particular application. It is determined for each user if the personal renewal price is less than the standard renewal price of the respective particular application in use by the user (step 348). When the personal renewal price is not less than the standard price for a particular user, the particular user is removed from further action in the auto renewal process (step 350), and such users are offered the standard renewal price.

For users for which the personal renewal price is less than the standard renewal price, the process continues at step 352 in which the users are split into two groups, a subset A group and a subset B group. A change price API is called to update the renewal price associated with the user for a particular application from the standard price to the personal price each user in subset A (step 356). The standard price for applications is maintained for the users in subset B. Beneficially, user renewal rates for users in subset A (offered a reduced personal price) and users in subset B (offered an un-reduced standard price) are compared to determine the effectiveness of the model. The model can for example be retrained based on the comparison. Alternatively, the steps 352 and 354 can be omitted if retraining is not required, and when it is determined that the personal renewal price is less than the standard renewal price (step 348), the process can continue at step 356.

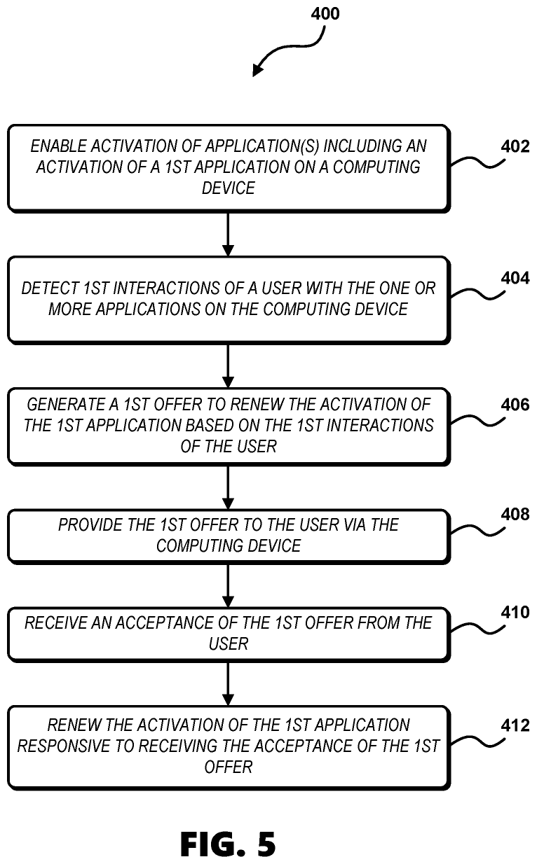

Referring to FIG. 5, a method 400 for activating an application is shown. The method 400 is described with reference to the components in the environment 10. Alternatively, the method 400 can be performed via other components in other environments and is not restricted to being implemented by the so described components.

In a step 402, an activation of one or more applications including an activation of a first application is enabled on a computing device. A first plurality of interactions of a user with the one or more applications on the computing device are detected (step 404). For example, a plurality of displays can be provided by the one or more applications, wherein detecting the first plurality of interactions of the user with the one or more applications can include detecting a first plurality of interactions with the plurality of displays.

A first offer to renew the activation of the first application is generated based on the first plurality of interactions of the user (step 406). The first offer is provided to the user via the computing device (step 408). An acceptance of the first offer is received from the user (step 410), and the activation of the first application is renewed responsive to receiving the acceptance of the first offer (step 412).

In an example implementation of the method 400, enabling the activation of the one or more applications can include enabling activations of a plurality of applications including an activation of the first application and an activation of a second application, and detecting the first plurality of interactions of the user with the one or more applications can include detecting at least a first interaction with the first application and at least a second interaction with the second application. The detecting of the interactions can be performed for example by the computing device via an agent (e.g., the activation agent 16) in communication with the first application and the second application.

A duration of time of activation of the one or more applications can be determined, and the first offer to renew the activation of the first application can be generated further based on the duration of time of activation of the one or more applications. In a particular implementation, enabling the activation of the one or more applications can include enabling activations of a plurality of applications. A duration of time of activation of one or more of the plurality of applications can be determined, and the first offer to renew the activation of the first application can be generated further based on the duration of time of activation of the one or more of the plurality of applications. The duration of time can be for example a month, a year, or a plurality of years.

In an extension to the method 400, a query is provided to the user via the first application regarding a rating of the first application. A response is received from the user to the query, and the first offer to renew the activation of the first application is generated further based on the response to the query. In a further extension to the method 400, one or more ratings can be received from the user for the one or more applications, and the first offer to renew the activation of the first application can be generated further based on the one or more ratings.

In a further extension to the method 400, the first application can include a first antivirus application installed on the computing device. The computing device can be monitored for installed applications. A second antivirus application installed on the computing device can be detected, and the first offer to renew the activation of the first application can be generated further based on the detection of the second antivirus application installed on the computing device. Further, one or more additional antivirus applications (e.g., third, fourth, and fifth antivirus applications) can be detected and the first offer to renew the activation of the first application can be generated further based on the detection of the additional antivirus applications.

In a further extension to the method 400, one or both of a processor or a random-access memory (“RAM”) of the computing device is determined, and the first offer to renew the activation of the first application is generated further based on the one or both of the processor or the RAM of the computing device. Alternatively, other hardware of the computing device can be determined, and the offer to renew the activation of the first application can be generated further based on the other hardware.

In a further extension to the method 400, a physical location of the computing device is determined, and the first offer to renew the activation of the first application is generated further based on the physical location of the computing device. The physical location can be determined for example via global positioning system (“GPS”) hardware on the computing device or other location determining system (“LDS”) (e.g., the LDS 56) on the computing device. The physical location can alternatively be determined based on an external internet protocol (“IP”) address of the computing device. The physical location can alternatively be provided by the user for example in the form of a home address, for example during initiation of the first application.

In a further extension to the method 400, enabling the activation of the one or more applications can include enabling activations of a plurality of applications. A number of the plurality of applications can be determined, and the first offer to renew the activation of the first application can be generated further based on the number of the plurality of applications. For example, a particular application service provider can provide a particular number of applications to the user for installation on the computing device, and the first offer to renew the activation of the first application can be generated by the particular application service provider based on the number of the plurality of applications of the particular application service provider installed on the computing device.

In a further extension to the method 400, a number of days during which the first plurality of interactions occurred can be determined, and the first offer to renew the activation of the first application can be determined further based on the number of days during which the first plurality of interactions occurred. For example, it can be determined that a user is active on the first application for three days in a particular month, and the first offer to renew the activation of the first application can be determined further based on the determining of the three days active during the particular month.

In a further extension to the method 400, a second plurality of interactions of the user with the one or more applications on the computing device is detected after renewing the activation of the first application. A second offer to renew the activation of the first application is generated based on the second plurality of interactions of the user, or alternatively, based on the first plurality of interactions of the user and the second plurality of interactions of the user. An acceptance of the second offer is received from the second user, and the activation of the first application is renewed again responsive to receiving the acceptance of the second offer.

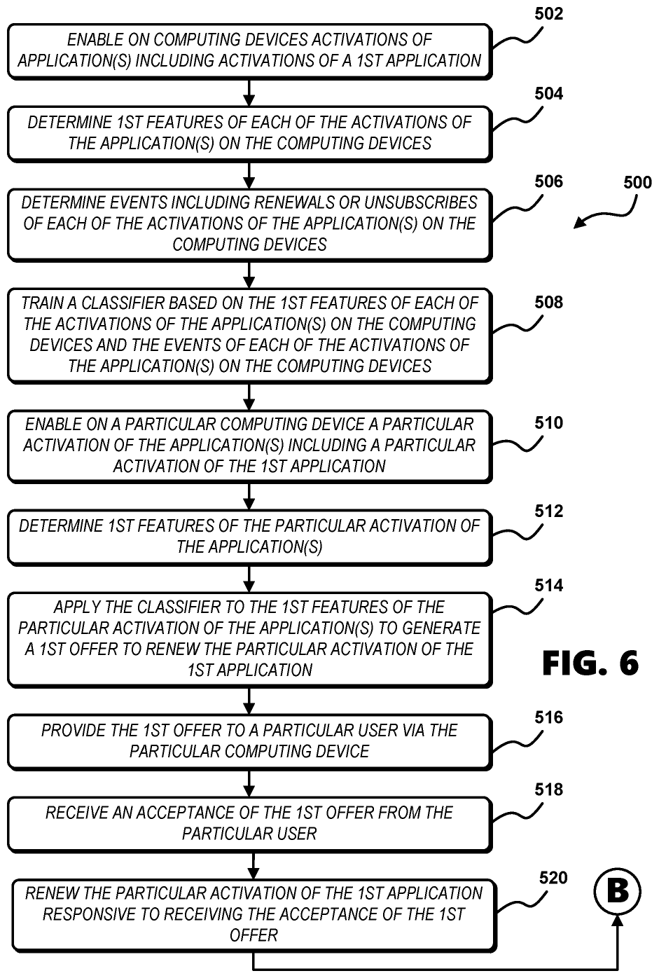

Referring to FIG. 6, a method 500 for activating an application is shown. The method 500 is described with reference to the components in the environment 10. Alternatively, the method 500 can be performed via other components in other environments and is not restricted to being implemented by the so described components.

The method 500 includes enabling on a plurality of computing devices a plurality of activations of one or more applications including a plurality of activations of a first application (step 502). A first plurality of features of each of the plurality of activations of the one or more applications on the plurality of computing devices are determined (step 504). A plurality of events including one or both of renewals or unsubscribes of each of the plurality of activations of the one or more applications on the plurality of computing devices are determined (step 506). A classifier is trained based on the first plurality of features of each of the plurality of activations of the one or more applications on the plurality of computing devices and the plurality of events of each of the plurality of activations of the one or more applications on the plurality of computing devices (step 508).

In the method 500, the classifier can include for example one or more of a logistic regression classifier, a random forest classifier, or a neural network classifier. The classifier can be trained based on the first plurality of features of each of the plurality of activations of the one or more applications on the plurality of computing devices as inputs of the classifier, and the plurality of events of each of the plurality of activations of the one or more applications on the plurality of computing devices as outputs of the classifier.

The method 500 further includes enabling on a particular computing device a particular activation of the one or more applications including a particular activation of the first application (step 510). A first plurality of features of the particular activation of the one or more applications are determined (step 512). The classifier is applied to the first plurality of features of the particular activation of the one or more applications to generate a first offer to renew the particular activation of the first application (step 514). The first offer is provided to a particular user via the particular computing device (step 516). An acceptance of the first offer is received from the particular user via the particular computing device (step 518), and the particular activation of the first application is renewed responsive to receiving the acceptance of the first offer (step 520).

In the method 500, the first plurality of features of the plurality of activations of the one or more applications can include a first plurality of interactions of each of a plurality of users with the one or more applications on each of the plurality of computing devices respectively, and the first plurality of features of the particular activation of the one or more applications can include a first plurality of interactions of the particular user with the one or more applications on the particular computing device.

The first plurality of features of the plurality of activations of the one or more applications can further include a first plurality active days of the one or more applications on each of the plurality of computing devices, and the first plurality of features of the particular activation of the one or more applications can further include a first plurality of active days of the one or more applications on the particular computing device. Active days of an application as defined herein include days when a user interacts with the application.

In the method 500, enabling on the plurality of computing devices the plurality of activations of the one or more applications can include enabling activations of a plurality of applications on the plurality of computing devices. The first plurality of features of the plurality of activations of the one or more applications can further include a number of the plurality of applications on each of the plurality of computing devices. Enabling on the particular computing device the particular activation of the one or more applications can include enabling activations of a plurality of applications on the particular computing device, and the first plurality of features of the particular activation of the one or more applications can further include a number of the plurality of applications on the particular computing device.

In the method 500, the first plurality of features of the plurality of activations of the one or more applications can further include one or more ratings from each of the plurality of users for the one or more applications on each of the plurality of computing devices respectively, and the first plurality of features of the particular activation of the one or more applications can further include one or more ratings from the particular user for the one or more applications on the particular computing device.

In the method 500, the first plurality of features of the plurality of activations of the one or more applications can further include one or more physical locations of each of the plurality of users of each of the plurality of computing devices respectively, and the first plurality of features of the particular activation of the one or more applications can further include one or more physical locations of the particular user.

In the method 500, enabling on the particular computing device the particular activation of the one or more applications can include enabling activations of a plurality of applications on the particular computing device including the first application and a second application, and the first plurality of features of the particular activation of the one or more applications can further include at least a first interaction with the first application and at least a second interaction with the second application.

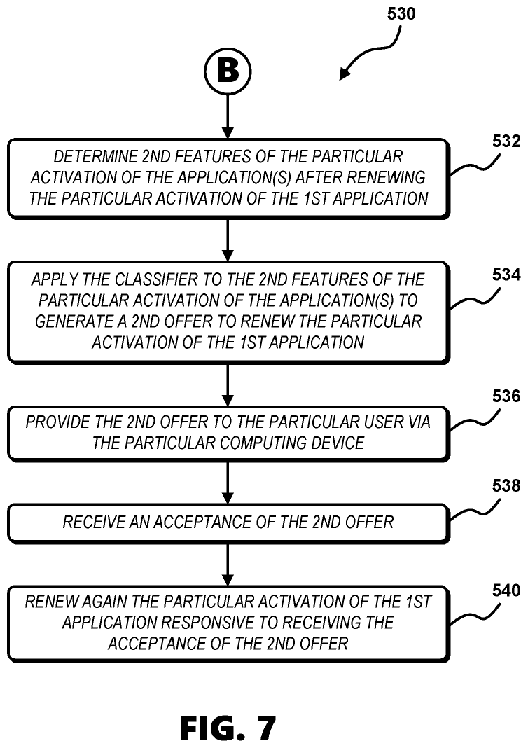

Referring to FIGS. 6 and 7, an extension 530 to the method 500 continuing at an input “B” from step 520 includes determining a second plurality of features of the particular activation of the one or more applications after renewing the particular activation of the first application (step 532). The classifier is applied to the second plurality of features of the particular activation of the one or more applications to generate a second offer to renew the particular activation of the first application (step 534). The second offer is provided to the particular user via the particular computing device (step 536). An acceptance of the second offer is received (step 538), and the particular activation of the first application is renewed again responsive to receiving the acceptance of the second offer (step 540).

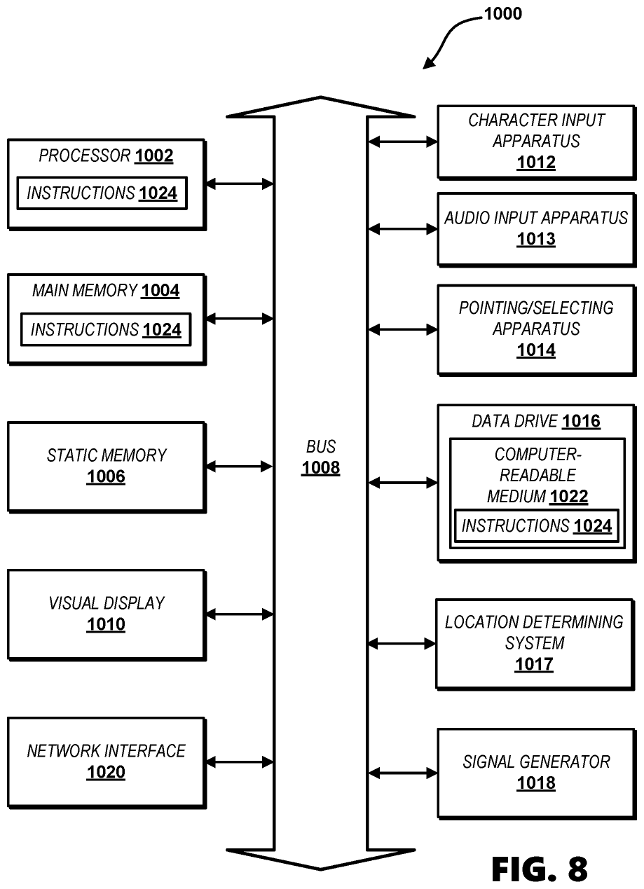

FIG. 8 illustrates in abstract the function of an exemplary computer system 1000 on which the systems, methods and processes described herein can execute. For example, the computing device 12 and the activation manager 20 can each be embodied by a particular computer system 1000 or a plurality of computer systems 1000. The computer system 1000 may be provided in the form of a personal computer, laptop, handheld mobile communication device, mainframe, distributed computing system, or other suitable configuration. Illustrative subject matter is in some instances described herein as computer-executable instructions, for example in the form of program modules, which program modules can include programs, routines, objects, data structures, components, or architecture configured to perform particular tasks or implement particular abstract data types. The computer-executable instructions are represented for example by instructions 1024 executable by the computer system 1000.

The computer system 1000 can operate as a standalone device or can be connected (e.g., networked) to other machines. In a networked deployment, the computer system 1000 may operate in the capacity of a server or a client machine in server-client network environment, or as a peer machine in a peer-to-peer (or distributed) network environment. The computer system 1000 can also be considered to include a collection of machines that individually or jointly execute a set (or multiple sets) of instructions to perform one or more of the methodologies described herein, for example in a cloud computing environment.

It would be understood by those skilled in the art that other computer systems including but not limited to networkable personal computers, minicomputers, mainframe computers, handheld mobile communication devices, multiprocessor systems, microprocessor-based or programmable electronics, and smart phones could be used to enable the systems, methods and processes described herein. Such computer systems can moreover be configured as distributed computer environments where program modules are enabled and tasks are performed by processing devices linked through a computer network, and in which program modules can be located in both local and remote memory storage devices.

The exemplary computer system 1000 includes a processor 1002, for example a central processing unit (CPU) or a graphics processing unit (GPU), a main memory 1004, and a static memory 1006 in communication via a bus 1008. A visual display 1010 for example a liquid crystal display (LCD), light emitting diode (LED) display or a cathode ray tube (CRT) is provided for displaying data to a user of the computer system 1000. The visual display 1010 can be enabled to receive data input from a user for example via a resistive or capacitive touch screen. A character input apparatus 1012 can be provided for example in the form of a physical keyboard, or alternatively, a program module which enables a user-interactive simulated keyboard on the visual display 1010 and actuatable for example using a resistive or capacitive touchscreen. An audio input apparatus 1013, for example a microphone, enables audible language input which can be converted to textual input by the processor 1002 via the instructions 1024. A pointing/selecting apparatus 1014 can be provided, for example in the form of a computer mouse or enabled via a resistive or capacitive touch screen in the visual display 1010. A data drive 1016, a signal generator 1018 such as an audio speaker, and a network interface 1020 can also be provided. A location determining system 1017 is also provided which can include for example a GPS receiver and supporting hardware.

The instructions 1024 and data structures embodying or used by the herein-described systems, methods, and processes, for example software instructions, are stored on a computer-readable medium 1022 and are accessible via the data drive 1016. Further, the instructions 1024 can completely or partially reside for a particular time period in the main memory 1004 or within the processor 1002 when the instructions 1024 are executed. The main memory 1004 and the processor 1002 are also as such considered computer-readable media.

While the computer-readable medium 1022 is shown as a single medium, the computer-readable medium 1022 can be considered to include a single medium or multiple media, for example in a centralized or distributed database, or associated caches and servers, that store the instructions 1024. The computer-readable medium 1022 can be considered to include any tangible medium that can store, encode, or carry instructions for execution by a machine and that cause the machine to perform any one or more of the methodologies described herein, or that can store, encode, or carry data structures used by or associated with such instructions. Further, the term “computer-readable storage medium” can be considered to include, but is not limited to, solid-state memories and optical and magnetic media that can store information in a non-transitory manner. Computer-readable media can for example include non-volatile memory such as semiconductor memory devices (e.g., magnetic disks such as internal hard disks and removable disks, magneto-optical disks, CD-ROM and DVD-ROM disks, Erasable Programmable Read-Only Memory (EPROM), Electrically Erasable Programmable Read-Only Memory (EEPROM), and flash memory devices).

The instructions 1024 can be transmitted or received over a computer network, for example the computer network 8, using a signal transmission medium via the network interface 1020 operating under one or more known transfer protocols, for example FTP, HTTP, or HTTPs. Examples of computer networks include a local area network (LAN), a wide area network (WAN), the internet, mobile telephone networks, Plain Old Telephone (POTS) networks, and wireless data networks, for example Wi-Fi™ and 3G/4G/5G cellular networks. The term “computer-readable signal medium” can be considered to include any transitory intangible medium that is capable of storing, encoding, or carrying instructions for execution by a machine, and includes digital or analog communications signals or other intangible medium to facilitate communication of such instructions.

Although features and elements are described above in particular combinations, one of ordinary skill in the art will appreciate that each feature or element can be used alone or in any combination with the other features and elements. Methods described herein may be implemented in a computer program, software, or firmware incorporated in a computer-readable medium for execution by a computer or processor.

While embodiments have been described in detail above, these embodiments are non-limiting and should be considered as merely exemplary. Modifications and extensions may be developed, and all such modifications are deemed to be within the scope defined by the appended claims.

What is claimed is:

1. An application activation method comprising:
enabling an activation of at least one application, including an activation of a first application, on a computing device;
detecting a first plurality of interactions of a user with the at least one application on the computing device;
generating a first offer to renew the activation of the first application based on the first plurality of interactions of the user;
providing the first offer to the user via the computing device;
receiving an acceptance of the first offer from the user; and
renewing the activation of the first application responsive to receiving the acceptance of the first offer.

2. The method of claim 1, wherein:
enabling the activation of the at least one application comprises enabling activations of a plurality of applications comprising an activation of the first application and an activation of a second application; and
detecting the first plurality of interactions of the user with the at least one application comprises detecting at least a first interaction with the first application and at least a second interaction with the second application.

3. The method of claim 1, wherein:
determining a duration of time of activation of the at least one application; and
generating the first offer to renew the activation of the first application further based on the duration of time of activation of the at least one application.

4. The method of claim 1, wherein:
enabling the activation of the at least one application comprises enabling activations of a plurality of applications;
determining a duration of time of activation of at least one of the plurality of applications; and
generating the first offer to renew the activation of the first application further based on the duration of time of activation of the at least one of the plurality of applications.

5. The method of claim 1, further comprising providing a plurality of displays by the at least one application, wherein detecting the first plurality of interactions of the user with the at least one application comprises detecting a first plurality of interactions with the plurality of displays.

6. The method of claim 1, further comprising:
providing a query to the user via the first application regarding a rating of the first application;
receiving a response from the user to the query; and
generating the first offer to renew the activation of the first application further based on the response to the query.

7. The method of claim 1, wherein the first application comprises a first antivirus application installed on the computing device, the method further comprising:
monitoring the computing device for installed applications;
detecting a second antivirus application installed on the computing device; and
generating the first offer to renew the activation of the first application further based on the detection of the second antivirus application installed on the computing device.

8. The method of claim 1, further comprising:
receiving at least one rating from the user for the at least one application; and
generating the first offer to renew the activation of the first application further based on the at least one rating.

9. The method of claim 1, further comprising:
determining at least one of a processor or random-access memory (“RAM”) of the computing device; and
generating the first offer to renew the activation of the first application further based on the at least one of the processor or the RAM of the computing device.

10. The method of claim 1, further comprising:
determining a physical location of the computing device; and
generating the first offer to renew the activation of the first application further based on the physical location of the computing device.

11. The method of claim 1, wherein enabling the activation of the at least one application comprises enabling activations of a plurality of applications, the method further comprising:
determining a number of the plurality of applications; and
generating the first offer to renew the activation of the first application further based on the number of the plurality of applications.

12. The method of claim 1, further comprising:
determining a number of days during which the first plurality of interactions occurred; and
generating the first offer to renew the activation of the first application further based on the number of days during which the first plurality of interactions occurred.

13. The method of claim 1, further comprising:
detecting a second plurality of interactions of the user with the at least one application on the computing device after renewing the activation of the first application;
generating a second offer to renew the activation of the first application based on the second plurality of interactions of the user;
receiving an acceptance of the second offer from the user; and
renewing again the activation of the first application responsive to receiving the acceptance of the second offer.

14. The method of claim 1, further comprising:
detecting a second plurality of interactions of the user with the at least one application on the computing device after renewing the activation of the first application;
generating a second offer to renew the activation of the first application based on the first plurality of interactions of the user and the second plurality of interactions of the user;
receiving an acceptance of the second offer from the user; and
renewing again the activation of the first application responsive to receiving the acceptance of the second offer.

15. An application activation method comprising:
enabling on a plurality of computing devices a plurality of activations of at least one application comprising a plurality of activations of a first application;
determining a first plurality of features of each of the plurality of activations of the at least one application on the plurality of computing devices;
determining a plurality of events comprising at least one of renewals or unsubscribes of each of the plurality of activations of the at least one application on the plurality of computing devices;
training a classifier based on the first plurality of features of each of the plurality of activations of the at least one application on the plurality of computing devices and the plurality of events of each of the plurality of activations of the at least one application on the plurality of computing devices;
enabling on a particular computing device a particular activation of the at least one application comprising a particular activation of the first application;
determining a first plurality of features of the particular activation of the at least one application;
applying the classifier to the first plurality of features of the particular activation of the at least one application to generate a first offer to renew the particular activation of the first application;
providing the first offer to a particular user via the particular computing device;
receiving an acceptance of the first offer from the particular user via the particular computing device; and
renewing the particular activation of the first application responsive to receiving the acceptance of the first offer.

16. The method of claim 15, wherein:
the first plurality of features of the plurality of activations of the at least one application comprise a first plurality of interactions of each of a plurality of users with the at least one application on each of the plurality of computing devices respectively; and
the first plurality of features of the particular activation of the at least one application comprise a first plurality of interactions of the particular user with the at least one application on the particular computing device.

17. The method of claim 16, wherein:
the first plurality of features of the plurality of activations of the at least one application further comprise a first plurality active days of the at least one application on each of the plurality of computing devices; and
the first plurality of features of the particular activation of the at least one application further comprise a first plurality of active days of the at least one application on the particular computing device.

18. The method of claim 16, wherein:
enabling on the plurality of computing devices the plurality of activations of the at least one application comprises enabling activations of a plurality of applications on the plurality of computing devices;
the first plurality of features of the plurality of activations of the at least one application further comprise a number of the plurality of applications on each of the plurality of computing devices;
enabling on the particular computing device the particular activation of the at least one application comprises enabling activations of a plurality of applications on the particular computing device; and
the first plurality of features of the particular activation of the at least one application further comprise a number of the plurality of applications on the particular computing device.

19. The method of claim 16, wherein:
the first plurality of features of the plurality of activations of the at least one application further comprise at least one rating from each of the plurality of users for the at least one application on each of the plurality of computing devices respectively; and
the first plurality of features of the particular activation of the at least one application further comprise at least one rating from the particular user for the at least one application on the particular computing device.

20. The method of claim 16, wherein:
the first plurality of features of the plurality of activations of the at least one application further comprise at least one physical location of each of the plurality of users of each of the plurality of computing devices respectively; and
the first plurality of features of the particular activation of the at least one application further comprise at least one physical location of the particular user.

21. The method of claim 16, wherein:
enabling on the particular computing device the particular activation of the at least one application comprises enabling activations of a plurality of applications on the particular computing device comprising the first application and a second application; and
the first plurality of features of the particular activation of the at least one application further comprise at least a first interaction with the first application and at least a second interaction with the second application.

22. The method of claim 15, further comprising:
determining a second plurality of features of the particular activation of the at least one application after renewing the particular activation of the first application;
applying the classifier to the second plurality of features of the particular activation of the at least one application to generate a second offer to renew the particular activation of the first application;
providing the second offer to the particular user via the particular computing device;
receiving an acceptance of the second offer; and
renewing again the particular activation of the first application responsive to receiving the acceptance of the second offer.

23. The method of claim 15, wherein the classifier comprises at least one of a logistic regression classifier, random forests classifier, or a neural network classifier.

24. The method of claim 15, further comprising training the classifier based on the first plurality of features of each of the plurality of activations of the at least one application on the plurality of computing devices as inputs of the classifier, and the plurality of events of each of the plurality of activations of the at least one application on the plurality of computing devices as outputs of the classifier.

25. An application activation system comprising one or more processors and one or more storage devices coupled to the one or more processors and storing computer-executable instructions, wherein the computer-executable instructions, when executed by the one or more processors, cause the application activation system to perform operations comprising:
enabling on a plurality of computing devices a plurality of activations of at least one application comprising a plurality of activations of a first application;
determining a first plurality of features of each of the plurality of activations of the at least one application on the plurality of computing devices;
determining a plurality of events comprising at least one of renewals or unsubscribes of each of the plurality of activations of the at least one application on the plurality of computing devices;
training a classifier based on the first plurality of features of each of the plurality of activations of the at least one application on the plurality of computing devices and the plurality of events of each of the plurality of activations of the at least one application on the plurality of computing devices;
enabling on a particular computing device a particular activation of the at least one application comprising a particular activation of the first application;
determining a first plurality of features of the particular activation of the at least one application;
applying the classifier to the first plurality of features of the particular activation of the at least one application to generate a first offer to renew the particular activation of the first application;
providing the first offer to a particular user via the particular computing device;
receiving an acceptance of the first offer from the particular user; and
renewing the particular activation of the first application responsive to receiving the acceptance of the first offer.

26. A non-transitory computer readable storage medium having computer-executable instructions that when executed cause one or more processors to perform operations comprising:
enabling on a plurality of computing devices a plurality of activations of at least one application comprising a plurality of activations of a first application;
determining a first plurality of features of each of the plurality of activations of the at least one application on the plurality of computing devices;
determining a plurality of events comprising at least one of renewals or unsubscribes of each of the plurality of activations of the at least one application on the plurality of computing devices;
training a classifier based on the first plurality of features of each of the plurality of activations of the at least one application on the plurality of computing devices and the plurality of events of each of the plurality of activations of the at least one application on the plurality of computing devices;
enabling on a particular computing device a particular activation of the at least one application comprising a particular activation of the first application;
determining a first plurality of features of the particular activation of the at least one application;
applying the classifier to the first plurality of features of the particular activation of the at least one application to generate a first offer to renew the particular activation of the first application;
providing the first offer to a particular user via the particular computing device;
receiving an acceptance of the first offer from the particular user; and
renewing the particular activation of the first application responsive to receiving the acceptance of the first offer.

27. A method comprising:
enabling on a plurality of computing devices a plurality of activations of at least one application comprising a plurality of activations of a first application;
determining a first plurality of features of each of the plurality of activations of the at least one application on the plurality of computing devices, the first plurality of features comprising a first plurality of interactions of each of a plurality of users with the at least one application on each of the plurality of computing devices respectively;
determining a plurality of events comprising at least one of renewals or unsubscribes of each of the plurality of activations of the at least one application on the plurality of computing devices;
training a classifier based on the first plurality of features of each of the plurality of activations of the at least one application on the plurality of computing devices and the plurality of events of each of the plurality of activations of the at least one application on the plurality of computing devices;
enabling on a particular computing device a particular activation of the at least one application comprising a particular activation of the first application;
determining a first plurality of features of the particular activation of the at least one application;
applying the classifier to the first plurality of features of the particular activation of the at least one application to generate a first offer regarding the first application;
providing the first offer to a particular user via the particular computing device;
determining a second plurality of features of the particular activation of the at least one application after providing the first offer to the particular user, the second plurality of features of the plurality of activations of the at least one application comprising a second plurality of interactions of each of the plurality of users with the at least one application on each of the plurality of computing devices respectively;
applying the classifier to the second plurality of features of the particular activation of the at least one application to generate a second offer regarding the first application; and
providing the second offer to the particular user via the particular computing device.
